(19) United States
(12) Patent Application Publication
(10) Pub. No.: US 2012/0169078 A1
(43) Pub. Date: Jul. 5, 2012

(54) GRIPPER FOR A MANIPULATOR

(76) Inventor: Johannes Wilhelmus Maria Konings, Ysselsteyn (NL)

(21) Appl. No.: 13/059,043

(22) PCT Filed: Aug. 13, 2009
(86) PCT No.: PCT/NL2009/000158

§ 371 Date: Mar. 2, 2011

(30) Foreign Application Priority Data
Aug. 14, 2008 (NL) 2001889

(51) Int. Cl. B25J 15/06; B66C 1/42; B25J 15/08

(52) U.S. Cl. 294/64.3; 294/183; 294/186

(57) ABSTRACT

A gripper for grasping a bag has a frame with two clamping components and two fingers which are pivotably connected to the frame. The gripper further includes a suction pad which is displaceably connected to the frame. By first grasping the bag with the suction pad and lifting it, the bag can subsequently be clamped in a simple manner by turning the gripper until the bag is located between the clamping components and the extremities of the fingers. Since the suction pad is freely movable, the bag continues to hold the same position while the gripper is being turned. The gripper further has four pins which can be stuck through the bag so as to hold it in the vertical position of the gripper.

### BACKGROUND OF THE INVENTION

1. Field of the Invention

The invention relates to a gripper for a manipulator for grasping products, more specifically filled bags.

2. Description of Related Art

A gripper of this type is generally known. The known gripper can, for example, be instrumental in clamping a filled bag between the clamping component and the free extremity of the finger. Filled bags may be supplied by a belt conveyor or lie against one another on a pallet and are to be picked up. Sometimes robots with grippers are used for this purpose. It is awkward to open a bag with a relatively simple gripper. As a result the known gripper is relatively complex.

### SUMMARY OF THE INVENTION

It is an object of the invention to provide a gripper of the type defined in the opening paragraph which is relatively simple and with which bags can be grasped very well. For this purpose the gripper according to the invention is characterised in that the gripper further includes at least a single suction pad connected to the mounting element. By initially grasping a bag with a suction pad and lifting it, the bag can then be clamped in a simple manner.

An embodiment of the gripper according to the invention is characterised in that the suction pad is displaceably connected to the mounting element and has a suction opening which is confined by a boundary edge, the suction pad being movable to an active state in which the suction pad with the boundary edge is located in the clamping surface. Then only the finger needs to be displaced to clamp the bag.

Preferably, the suction pad is pivotably connected to the mounting element. The advantage of this is that the bag continues to be in the same position during the turning action of the gripper.

The gripper may also comprise displacement means for the suction pad, which displacement means are connected to the mounting element.

Furthermore, the gripper preferably comprises at least a single further suction pad which is displaceably connected to the frame and which can be displaced to a position in which the further suction pad is placed opposite to the suction pad already present. This further suction pad is preferably connected to the displaceable finger.

After the bags have been lifted they are to be opened and emptied. For this purpose the bag is preferably held vertical and cut open at the bottom and preferably also at the two sides. The bag can be cut open in that the robot moves the bag past a cutting device. When a filled bag is opened it loses its rigidity so that the bag can no longer be held tight by the suction pad or suction pads. Furthermore, the bag can no longer be flattened completely because otherwise part of the contents will stay behind in the bag.

An embodiment of the gripper according to the invention with which a filled bag can be held tight also during the emptying operation is characterised in that the gripper further comprises at least a single frame-connected pin, which pin is displaceable to a position in which it can stick into the product to be grasped and holds it like that. Preferably the gripper comprises in addition to the said pin at least a single frame-connected further pin, with the pins forming a pair and being located at two spots facing each other beside the suction pad when the gripper is in the active state.

A further embodiment of the gripper according to the invention is characterised in that the gripper comprises in addition to said pair of pins at least a single frame-connected further pair of pins of which the pins are located on the pair of pins' sides that are turned away from the suction pad. As a result, bags of different sizes can always be retained by at least two pins.

Yet a further embodiment of the gripper according to the invention is characterised in that the pin or the pins can be displaced parallel to the clamping surface. As a result, a greater variety of bags can be retained.

In again a further embodiment of the invention the pin or pins are provided with a channel and compressed air channels are present for blowing air through the pin or pins.

Yet again a further embodiment of the gripper according to the invention is characterised in that the frame comprises in addition to said clamping component a further clamping component which is located in the clamping surface, while the suction pad in active state is located in between the clamping components and in that the gripper comprises a further finger in addition to said finger, with the fingers being located opposite to the clamping components.

Each finger is preferably provided with one or more further suction pads for opening up the bags once they have been cut open.

In yet again a further embodiment these fingers too can be displaced parallel to the clamping surface to be able to process a greater variety of bags.

Preferably, the pins are located on either one of the two sides of the clamping components. Furthermore, the gripper is preferably a clamping plate which is fitted to the clamping components and is located in the clamping surface.

### BRIEF DESCRIPTION OF THE DRAWINGS

The invention will now be described in more detail below based on an example of embodiment of the gripper according to the invention while reference is made to the appended drawing figures, in which:

FIG. 1 shows a perspective view of an embodiment of the gripper according to the invention;

FIG. 2 shows a side view of the gripper during the suction of a bag;

FIG. 3 shows the situation during the turning action of the gripper with the clamping components and fingers being caused to surround the bag;

FIG. 4 shows the gripper in a position in which the bag is clamped in horizontal position;

FIG. 5 shows the gripper in the position in which the bag is held in a vertical position; and

FIG. 6 shows the gripper during the emptying of the bag.

### DETAILED DESCRIPTION

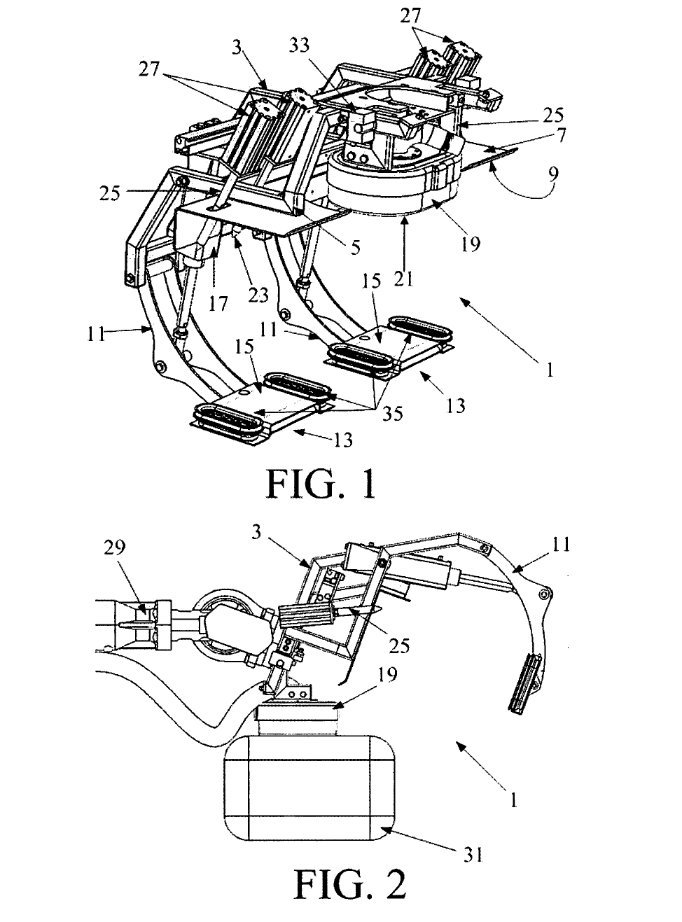

FIG. 1 shows a perspective view of an embodiment of the gripper according to the invention for gripping filled bags. The gripper 1 has a frame 3 comprised of two clamping components 5 to which a clamping plate 7 is fitted and which has a clamping surface 9.

The gripper 1 further has two fingers 11 which are pivotably connected to the frame 3. The fingers are shown in a position in which the free extremities 13 of the fingers are facing the clamping components 5. These free extremities are equipped with clamping plates 15 which are turnable. The fingers 11 can be moved by displacement means which are formed by two hydraulic or pneumatic cylinders 17.

Furthermore, the gripper 1 has a suction pad 19 which is displaceably connected to the frame 3 and is disposed between the clamping components 5. The suction pad has a suction opening which is confined along the periphery by a boundary edge 21. The gripper 1 in this Figure is shown to be in an active state in which the suction pad 19 with its boundary edge 21 is located in the clamping surface 9.

The gripper 1 further includes four pins 23, 25 which are displaceable between a retracted position, in which the pins are fully retracted to behind the clamping surface 9 (see FIG. 2), and a projected position in which the pins project out of the clamping surface (the position shown in FIG. 1). The pins can be displaced by means of further hydraulic or pneumatic cylinders 27. The pins form two pairs while the pins 23 or 25 respectively of each pair are located at two spots beside the suction pad 19 facing each other and on either one of the two sides of the clamping components 5.

FIGS. 2 to 6 show the various steps of the grasping of a bag from a conveyor belt or pallet and bringing the bag in vertical position, so that it can be opened at the bottom and sides and emptied.

FIG. 2 shows a side view of the gripper when a bag is sucked onto the suction pad. The gripper is connected to the extremity of a robot arm 29. The extremity of the robot arm is adjustable in every degree of freedom. The suction pad 19 has grasped a filled bag 31 and the robot has lifted the gripper. The frame 3 and the fingers 11 are turned away from the bag 31 and the pins 25 are in a retracted state.

For grasping the bag 31 in the correct manner (the bag does not always lie in the right position on the conveyor belt or pallet) a 2D or 3D camera (not shown) is fitted to the frame 3 or installed as a stationary camera. This camera is connected to a control system (not shown) which controls the gripper 1 in response to image recognition.

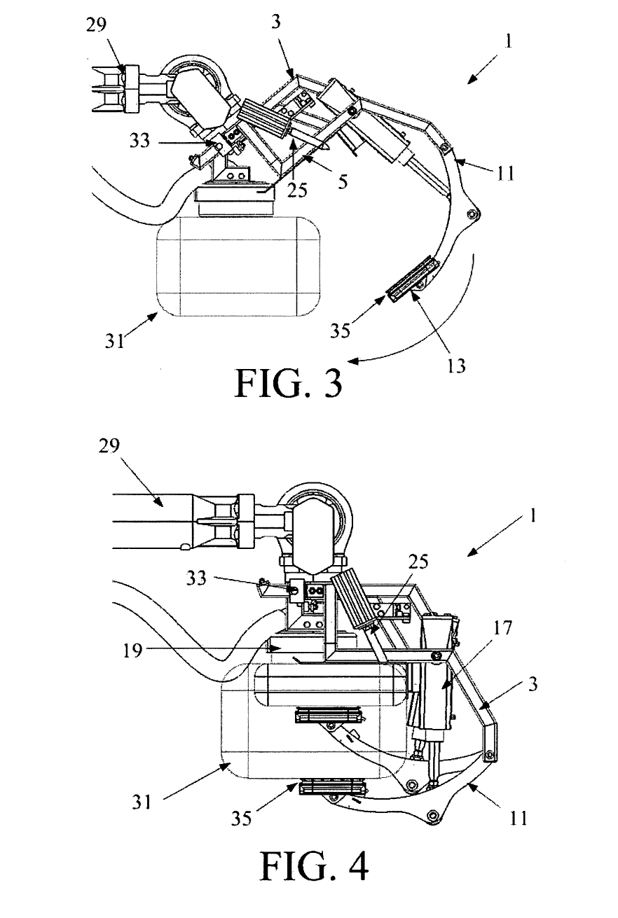

Subsequently, the frame 3 with the fingers 11 is turned by the robot arm 29 while the clamping components 5 and the extremities 13 of the fingers end up on either one of the two sides of the bag 31. FIG. 3 shows the situation during the turning action of the gripper 1.

In FIG. 4 the fingers 11 have ended right under the clamping surface subsequent to which the cylinders 17 press the fingers against the bag 31 (a small bag as well as a big bag are shown). The gripper 1 further has four further suction pads 35 which are present beside the clamping plates 15 and are also detachably connected to the free extremities of the fingers 11.

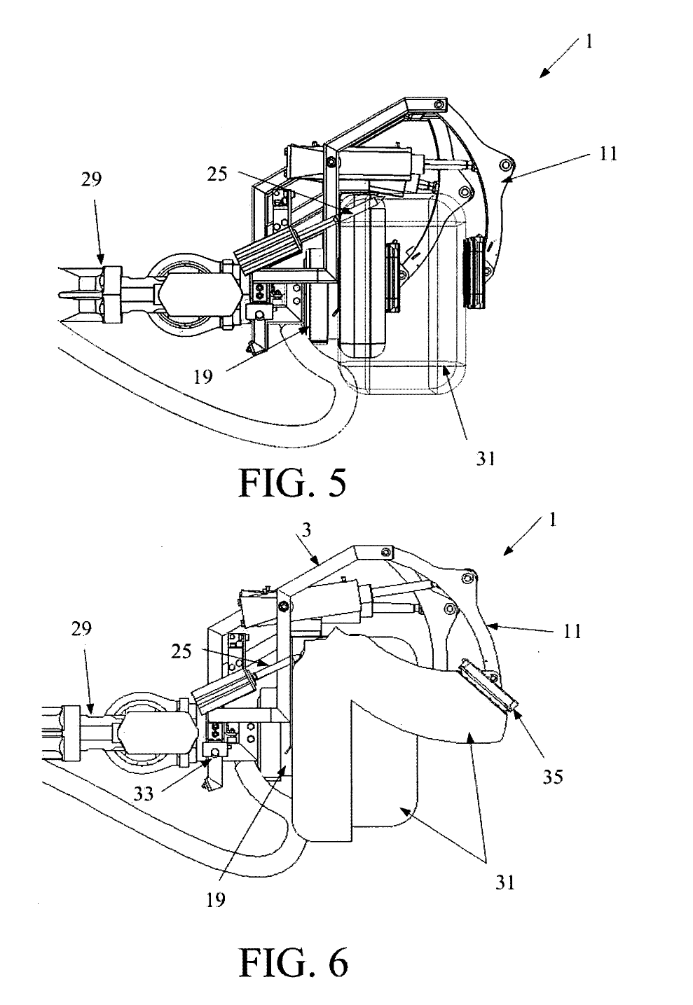

Then the gripper 1 is returned to the initial position by the robot arm 29 while the bag 31 (a small bag as well as a big bag are shown) is in a vertical position. This is shown in FIG. 5. In this position the bag 31 is cut open at the bottom and at the sides and then emptied, which is shown in FIG. 6.

This opening of the bag 31 is effected by having the bag 31 move past a stationary fixed or rotating cutting element (not shown). The fingers 11 with the further suction pads 35 mounted thereto tear the bag 31 open, so that the contents are falling out. During the emptying of the bag with the robot arm, but in lieu of this the bag can also be vibrated for example by having the suction pad 19 vibrate by means of the vibration means (not shown).

To prevent the bag 31 from falling down, the pins 25 are projected so that they pierce the bag and retain it in this way. The pins also hold the bag in better shape when the bag is emptied, more particularly the corners of the bag.

For emptying the bag 31 better and accelerating the emptying process the pins 25 may be provided with a channel and compressed air means (not shown) can blow air into the pins through the channels.

In the state shown in FIGS. 5 and 6 a brake pad 33 is controlled which prevents the suction pad 19 from lowering while the bag 31 is being emptied.

Albeit the invention has been described in the foregoing based on the drawings, it should be observed that the invention is not by any manner or means restricted to the embodiment shown in the drawings. The invention also extends to all embodiments deviating from the embodiment shown in the drawings within the spirit and scope defined by the claims.

1. A gripper for a manipulator for grasping a filled bag, the gripper comprising:
a mounting element with which the gripper can be mounted onto a manipulator;
a frame connected to the mounting element having at least a single clamping component located in a clamping surface against which clamping component the filled bag can be clamped;
at least a single displaceable frame-connected finger which is displaceable to a position in which the free extremity of the finger is positioned opposite to the clamping surface; and
a frame-connected displacement means for displacing the finger; and
at least a single suction pad connected to the mounting element.

2. The gripper as claimed in claim 1, wherein the suction pad is displaceably connected to the mounting element and has a suction opening which is confined by a boundary edge, the suction pad being movable to an active state in which the suction pad with the boundary edge is located in the clamping surface.

3. The gripper as claimed in claim 2, characterised in that the suction pad is pivotably connected to the mounting element.

4. The gripper as claimed in claim 2, characterised in that the suction pad can be turned by the displacement means connected to the mounting element.

5. The gripper as claimed in claim 1, wherein the gripper comprises at least a single further suction pad which is displaceably connected to the frame and which can be displaced to a position in which the further suction pad is placed opposite to the suction pad already present.

6. The gripper as claimed in claim 5, wherein the further suction pad is connected to the displaceable finger.

7. The gripper as claimed in claim 1, further comprising at least a single frame-connected pin, which pin is displaceable to a position in which it can stick into the product to be grasped.

8. The gripper as claimed in claim 7, further comprising at least a single frame-connected further pin, with the pins forming a pair and being located at two spots facing each other beside the suction pad when the gripper is in the active state.

9. The gripper as claimed in claim 8, further comprising at least a single frame-connected further pair of pins of which the pins are located on the pair of pins' sides that are turned away from the suction pad.

10. The gripper as claimed in claim 7, wherein the pin or the pins can be displaced parallel to the clamping surface.

11. The gripper as claimed in claim 7, wherein the pin or pins are provided with a channel and compressed air means are present for blowing air through the pin or pins.

12. The gripper as claimed in claim 1, wherein the frame comprises in addition to said clamping component a further clamping component which is located in the clamping surface, while the suction pad in the active state is located in between the clamping components and in that the gripper comprises a further finger in addition to said finger, with the fingers being located opposite to the clamping components.

13. The gripper as claimed in claim 12, wherein the fingers can be displaced parallel to the clamping surface.

14. The gripper as claimed in claim 8, wherein the pins are located on either one of the two sides of the clamping components.

15. The gripper as claimed in claim 1, further comprising a clamping plate which is fitted to the clamping components and is located in the clamping surface.

16. A gripper for a manipulator for grasping a filled bag, the gripper comprising:
a mounting element with which the gripper can be mounted onto a manipulator;
a frame connected to the mounting element having at least a single clamping component located in a clamping surface against which clamping component the filled bag can be clamped;
at least a single displaceable frame-connected finger which is displaceable to a position in which the free extremity of the finger is positioned opposite to the clamping surface; and
a frame-connected displacement means for displacing the finger;
at least a single suction pad connected to the mounting element; and
wherein the suction pad is displaceably connected to the mounting element and has a suction opening which is confined by a boundary edge, the suction pad being movable to an active state in which the suction pad with the boundary edge is located in the clamping surface.
